(19) United States
(12) Patent Application Publication
(10) Pub. No.: US 2026/0225845 A1
(43) Pub. Date: Aug. 6, 2026

(54) LINEAR TRANSPORT SYSTEM FOR TRANSPORTING ARTICLES AND METHOD FOR THE LINEAR TRANSPORT OF ARTICLES

(71) Applicant: G.D S.p.A, Bologna (IT)

(72) Inventors: Giuliano GAMBERINI, Bologna (IT); Maurizio ZANOTTI, Bologna (IT)

(21) Appl. No.: 19/155,025

(22) PCT Filed: Feb. 5, 2024
(86) PCT No.: PCT/IT2024/050029

§ 371 Date: Aug. 8, 2025

(30) Foreign Application Priority Data
Feb. 10, 2023 (IT) 102023000002334

(51) Int. Cl. B65H 45/18; B65G 17/32

(52) U.S. Cl. CPC B65H 45/18; B65G 17/323; B65H 2404/60

(57) ABSTRACT

Linear transport system (1), and method for the linear transport of articles, the system comprising a linear fixed guide (2), one or more support elements (3) slidingly engaging the fixed guide (2), each support element (3) comprising a contact surface (4) for receiving at least one portion of an article (A), and a first electrode (5) and a second electrode (6) in proximity of the contact surface (4), wherein the method comprises reversibly generating an electric field between the first electrode (5) and the second electrode (6 ), arranging a portion of an article (A) on the contact surface (4) subjected to the electric field for reversibly holding the portion of the article against the contact surface (4) by the electric field.

### TECHNICAL FIELD OF THE INVENTION

The present invention relates to a linear transport system, and a method for linear transport of articles. The present invention relates also to a machine comprising the aforesaid linear transport system.

### STATE OF THE ART

In the production plants, especially in the context of mass production of consumer products, including the packaging stage, it is known moving articles along treatment paths, for example by means of conveyor belts, carousels, etc.

### SUMMARY OF THE INVENTION

By the term “article” it is meant any physical object, including both a finished product and a semi-finished product during one or more phases of a respective production or treatment process. Examples of articles can be flat or folded sheets or three-dimensional objects, made of paper, cardboard, polymeric material, composite material, metallic material.

By the term “electro-adhesion” it is meant the ability to attract a material against a surface by generating reversible electric fields to which the material is subjected at that surface. Examples of electro-adhesive devices can be found in the article ‘Rapid Fabrication of Electro-Adhesive Devices with Inkjet Printed Electrodes’, IEEE Robotics And Automation Letters, Vol. 5, No. 2, April 2020, pp. 2770-2776, considered herein integrally incorporated.

By the expression “linear guide” it is meant a guide having line of main development (i.e. the physical dimension along which the guide predominantly develops) that extends in a plane or in the three-dimensional space with any form, e.g. by mutually combining straight stretches, curved stretches, flat, ascending, descending, horizontal, vertical stretches, etc. Typically, such line of main development (in use travelled by the support elements with a given direction) identifies a treatment path.

By the term “parallel” it is meant a substantial parallelism between two elements, comprising both the ideal case in which these elements are arranged one respect the other to form a null angle, and more frequent cases in which the two elements are arranged one respect the other to form an angle that deviates from the null angle (e.g. within a range of +-15°, more preferably +-10°, with respect to the null angle) but in any case negligible or irrelevant to the operation of the present solution.

By the term “perpendicular” it is meant a substantial perpendicularity between two elements, comprising both the ideal case in which these elements are arranged one respect the other to form a right angle, and more frequent cases in which the two elements are arranged one respect the other to form an angle that deviates from a right angle (e.g. within an interval of +-15°, more preferably +-10°, with respect to the right angle) but in any case negligible or irrelevant to the operation of the present solution.

In the aforesaid context, the Applicant has noted that, nowadays, the production requirements, especially in case of large-scale series production, of realizing large volumes in short timeframe, necessitate the handling of articles along the production lines with increasingly shorter cycle times.

Such requirements can result in high accelerations (positive and/or negative) experienced by the articles, for example in conjunction with stops and/or (re)starts at subsequent stations along the treatment path of the articles.

This involves the necessity of subjecting the articles to high restraining forces, in order to effectively counteract the high inertial forces corresponding to the aforesaid high accelerations, without the risk of the article being displaced and/or detached from the transport system.

Moreover, along the production/treatment lines, it often happens that it is necessary to transfer an article from one transport system to another separate transport system contiguous to the first one, for example for structural and/or technical reasons limiting the spatial extent of a given transport system. Such transfers from one transport system to another should take place within a very short time and with continuous and precise control of the position and orientation of the article. In practice, this translates into the need to annul a restraining force associated to the first transport system in short times, and at the same time to abruptly activate a second restraining force associated to the second transport system, while maintaining with continuity a restraining force on the article such to prevent misalignment, or even loss, of the article.

In the aforementioned framework of technical requirements to be met in the production facilities, the Applicant has noted that the known systems and methods for the linear transport of articles have certain drawbacks and/or can be improved under one or more aspects.

For example, the Applicant believes that the known systems for transporting articles, which use mechanical gripping organs and/or vacuum aspiration systems to hold the articles, are not technologically capable of satisfying the aforesaid technical requirements, for example in terms of restraining forces that can be developed in combination with low switch-on and switch-off times, useful to the aforesaid transitions between various transport systems along the same line.

Moreover, the known systems for transporting articles are complex to make and/or inefficient in terms of energy consumption.

The Applicant has therefore faced the problem of realising the linear transport of articles along a treatment path in a way that is constructively simple, economic, e.g. in terms of consumption, efficient and with high-performance, e.g. in terms of achievable restraining forces and reduced on/off times of these forces (to allow for rapid article transitions). According to the Applicant the aforementioned problem is solved by a linear transport system for transporting articles, and a method for the linear transport of articles, according to the attached claims and/or having one or more of the following features.

According to an aspect, the invention relates to a linear transport system for transporting articles.

Preferably said system comprises a linear fixed guide.

Preferably said system comprises one or more supporting elements slidingly engaging said fixed guide.

Preferably each support element comprises a contact surface to receive at least one portion of an article.

Preferably each support element comprises a first electrode and a second electrode, more preferably in proximity of said contact surface.

Preferably said system comprises an electric energy generator connected to said first electrode and second electrode of each support element for reversibly generating an electric field between each first electrode and second electrode at said contact surface for reversibly holding said portion of said article against said contact surface.

According to another aspect, the invention relates to a method for linear transport of articles.

Preferably said method comprises providing a linear transport system. Preferably said system comprises a linear fixed guide. Preferably said system comprises one or more support elements slidingly engaging said fixed guide. Preferably each support element comprises a contact surface for receiving at least one portion of an article. Preferably each support element comprises a first electrode and a second electrode, more preferably in proximity of said contact surface. Preferably said method comprises reversibly generating an electric field between said first electrode and second electrode of one or more of said one or more support elements at said respective contact surface.

Preferably said method comprises arranging a portion of an article on said contact surface of at least one of said one or more support elements, more preferably with said portion subjected to said electric field for reversibly holding said portion of said article against said contact surface by means of said electric field.

Preferably said method comprises moving said one or more support elements slidingly along said fixed guide for transporting said article.

According to the Applicant, the reversible generation of the electric field at the contact surface allows the portion of the article to be subjected to such electric field to maintain it in adhesion against the contact surface by electro-adhesion. The Applicant has in fact noted that the generation of reversible electric fields to generate electro-adhesion phenomena, to which the articles are subjected to, results particularly advantageous in the context of linear transport systems of articles along a treatment path, since it enables to obtain numerous advantages.

First of all, such technology allows to obtain desirable holding forces against the contact surface with structural simplicity, limited space requirements and low costs, both in terms of realization and operation, particularly if compared to suction systems and/or mechanical actuators.

Moreover, the use of electric fields for the generation of electrostatic adhesion forces allows to generate and/or cancel such forces in short times (for example in the order of milliseconds), to the advantage of the rapid exchange of items between subsequent linear transport systems. For instance, the generation of the electric field of desired intensity occurs in very short times starting from the application of the electric potential difference to the electrodes, unlike suction systems that typically require a longer time to establish the desired pressure difference (which then generates the adhesion effect on the article). Furthermore, the adhesion realised with the aforementioned reversible electric fields allows the machine to adapt in versatile way to different articles (by shape, size, weight), while substantially keeping the structure of the machine unchanged. Such ability is instead scarce or even completely absent in transport systems that exploit mechanical holding or suction systems, which are typically designed specifically for a given type of article.

The use of electric fields generates also little or no noise (contary, for instance, to suction systems), improving acoustic comfort for the operators.

Moreover, the use of electric fields (contrary, for instance, to mechanical systems) allows the retention of various types of articles (e.g. in the case of soft and/or porous, or fragile articles), avoiding compressive or tensile forces on them, and thus limiting possible crushing/stretching and/or damage.

The present invention in one or more of the aforementioned aspects may have one or more of the following preferred features.

Preferably each first electrode and second electrode has main development substantially two-dimensional, and more preferably parallel to said contact surface. In this way it is facilitated the planar distribution of the electric field, in advantage of the retention efficiency.

Preferably each first electrode and second electrode has comb shape with respective teeth mutually intermeshed. In this way it is improved the spatial uniformity of the electric field.

Preferably said electric energy generator is high voltage generator. Preferably said electric energy generator is low current generator. Preferably said electric energy generator is high voltage and low current generator. For example, the circulating currents are in the order of a few tens of micro Amperes, preferably less than or equal to 50 micro Amperes, preferably less than or equal to 50 micro Amperes, more preferably less than or equal to 30 micro Amperes, even more preferably less than or equal to 10 micro Amperes, and the voltages in the order of few kilo Volts, preferably greater than or equal to 1 kV. In this way it is improved the safety, and moreover, such generator is compatible with those typically used in certain types of linear transport devices.

Preferably each support element comprises a main body.

Preferably said main body comprises a carriage engaging said fixed guide.

Preferably each support element comprises a sustaining portion comprising said contact surface. Preferably said sustaining portion is arranged at opposite side of said fixed guide with respect to said main body.

Preferably said sustaining portion has a layered structure. Preferably said layered structure comprising, proceeding towards said contact surface (e.g. starting from the main body):
a first dielectric substrate;
said first electrode and second electrode arranged above said first dielectric substrate.

In this way the electrodes are isolated from the main body.

Preferably said layered structure further comprises a second dielectric substrate arranged (at least partially) above said first electrode and second electrode. More preferably said second dielectric substrate incorporates said first electrode and second electrode. Preferably said second substrate defines said contact surface. In this way the electrodes are protected and/or the safety is improved.

Preferably at least one of said first dielectric substrate and second dielectric substrate is made of flexible material. Alternatively, at least one of said first dielectric substrate and second dielectric substrate is made of rigid material. Preferably at least one of said first dielectric substrate and second dielectric substrate is made of extensible material. Preferably said first dielectric substrate and/or second dielectric substrate are made of one or more of the following materials: polypropylene, polyimide, elastomeric silicone, water-based polyurethane, cellulose acetate. In this way the substrates are resistant and economic.

Preferably said first electrode and second electrode are made of one or more of the following materials: copper, aluminium, electrically conductive silicone rubber. Preferably said first electrode and second electrode are made by one of the following methods: printing, etching (chemical or mechanical) and rolling, etching (chemical or mechanical) and coating, photolithography and coating.

Preferably said a linear transport system is structured for moving each support element slidingly along said fixed guide independently from the remaining support elements. In this way, each article portion/article can be transported independently from the other article portions/article. Moreover, in this way the linear transport system can be particularly suitable to be incorporated into a folding machine, as described below.

Preferably each support element comprises a respective independent drive unit. In this way it is realised in structurally simple way the possibility of moving each support element along the fixed guide independently from the others.

Preferably said linear transport system comprises a subsystem of contactless communication (e.g. transmission and/or reception) of a signal (e.g. power signal and/or data signals) between said fixed guide and each support element (more preferably the respective drive unit and/or a respective processing unit incorporated on the support element) and/or vice versa. For example, the signals can be mutually transmitted by inductive coupling between one or more stationary coils arranged on the fixed guide and one or more coils placed on each of the support elements. In this way, the coupling is simple, direct, free from friction (and therefore free from problems related to wear of the parts), and able to allow reciprocal transmission of signals both with stationary support elements and in motion along the guide.

According to a further aspect, the present invention relates to a machine comprising said linear transport system. Preferably said machine comprises a control unit connected to said linear transport system for commanding said one or more support elements in movement along said linear guide. Preferably said linear guide defines a treatment path. Preferably each drive unit is structured to be operated (e.g. powered and/or controlled) by said subsystem of communication, more preferably by said control unit.

In one embodiment said machine is a folding machine for folding sheet articles.

Preferably said machine comprises a folding station (along said treatment path). Preferably said folding station comprises (at least) a folding plane.

In one embodiment, said method further comprises making on said article one or more folds, wherein preferably said article is a sheet (e.g. initially flat).

The retention of sheet articles by electro-adhesive folding has resulted particularly advantageous in folding machines and folding processes.

Preferably said folding plane is perpendicular to said treatment path (e.g. perpendicular to the direction of motion of the support elements). The folding plane represents, for example, a virtual plane on which a fold of the sheet occurs. Such folding plane may, for instance, be a single plane for all the folds (if, for instance, they occur in time sequence in the same point), or it may be provided a plurality of mutually parallel planes, each for one or more respective folds. Again, the folding plane may be spatially fixed with respect to the fixed guide, or it may be movable (e.g. if the fold is made with the support elements in motion, the folding plane moves along the guide as the fold is made).

Preferably said control unit is further configured for commanding at least two support elements directly consecutive of said one or more support elements for reciprocally approaching, along said treatment path, said at least two support elements directly consecutive.

In one embodiment said machine comprises one or more folding elements. Preferably each folding element is alternately movable from one or more distal positions distal from said fixed guide to a proximal position proximal to said fixed guide in which said folding element lies onto said folding plane.

Preferably said control unit is configured for:
i) arranging said at least two support elements in proximity, and respectively upstream and downstream, of said folding plane along said treatment path;
ii) moving a respective folding element from one of said one or more distal positions to said proximal position for bringing into contact said respective folding element with said article;
iii) bringing said respective folding element back to one of said one or more distal positions.

The folding element, by contacting the sheet, advantageously contributes to the make of the folds, for example by pointing the sheet in the right direction.

Preferably generating said electric field comprises applying an electric voltage difference between said first electrode and second electrode greater than or equal to 0.5 kV, more preferably greater than or equal to 1 kV, and/or less than or equal to 8 kV, more preferably less than or equal to 7.6 kV. Such range of electric voltage values is particularly advantageous to the adhesion.

In one embodiment, said method comprises adjusting a surface extension of said electric field on said contact surface as a function of a shape and/or extension of a contact surface of said portion of article. In this way, the adhesion force is adjusted according to the given article. For instance, the surface extension of the electric field may be adjusted by varying the voltage applied to the electrodes and/or by selective supply of distinct portions of the first and/or second electrode, as described below.

In one embodiment, said first electrode is made of a plurality of first sub-electrodes. Preferably said second electrode is made of a plurality of second sub-electrodes.

Preferably each first sub-electrode of said plurality of first sub-electrodes is structured to be selectively (e.g. independently) activatable with respect to remaining first sub-electrodes of said plurality of first sub-electrodes. Preferably each second sub-electrode of said plurality of second sub-electrodes is structured to be selectively (e.g. independently) activatable with respect to remaining second sub-electrodes of said plurality of second sub-electrodes. The first sub-electrodes and the second sub-electrodes are therefore selectively activatable to generate an electric field as a function of a shape and/or extension of a contact surface of the portion of article.

Preferably generating said electric field comprises selectively activating one or more of said first sub-electrodes and/or one or more of said second sub-electrodes as a function of a shape and/or extension of a contact surface of said portion of article. In this way, the adjustment of the surface extension of the electric field is simple.

In one embodiment, said method further comprises:
removing said article from said contact surface of at least one of said one or more support elements, more preferably by deactivating said electric field;
arranging a respective portion of a further article resting onto said contact surface of at least one of said one or more support elements, wherein said respective portion of said further article has a shape and/or surface dimension different from a respective shape and/or surface dimension of said portion of said article;
moving said one or more support elements slidingly along said fixed guide for transporting said further article. In fact, the transport system according to the present invention allows, even with the same surface extension of the electric field, to hold articles of different shapes (possibly leaving part of the surface extension of the electric field unoccupied by the article). Such ability is not realisable with the known holding systems that exploit vacuum generation to create a suction effect on the article, as the suction holes not covered by the article can suck in dirt, create noise and/or functional problems. In one embodiment, said method further comprises:
providing a further linear transport system having one or more of the features of the aforementioned linear transport system, including a further linear fixed guide;
deactivating said electric field for removing said article from said contact surface of at least one of said one or more support elements;
reversibly generating a further electric field between a further first electrode and a further second electrode of one or more further support elements at a further respective contact surface of said further linear transport system;
arranging a further portion of said article on said further contact surface of said one or more further support elements, with said further portion subjected to said further electric field for reversibly holding said further portion of said article on rest on said further contact surface by said further electric field.

Preferably said method comprises moving said one or more further support elements slidingly along said further fixed guide for transporting said article.

It is specified that some of the steps of the method described above may be independent of the reported order of execution, except wherein a sequentiality or simultaneity between two or more steps is expressly indicated as necessary. Moreover, some steps may be optional. Furthermore, some steps may be performed repetitively, or they may be performed in series or in parallel with other steps of the method.

### BRIEF DESCRIPTION OF THE DRAWINGS

FIG. 1 shows, in partial and purely schematic way, a detail of a perspective view of a linear transport system according to the present invention;

FIG. 2 schematically shows a section of a portion of a linear transport system according to the present invention;

FIG. 3 shows in partial and purely schematic way a side view of a folding machine comprising the linear transport system according to the present invention.

### DETAILED DESCRIPTION OF SOME EMBODIMENTS OF THE INVENTION

The features and the advantages of the present invention will be further clarified by the following detailed description of some embodiments, presented by way of example and not limitation of the present invention, with reference to the attached figures.

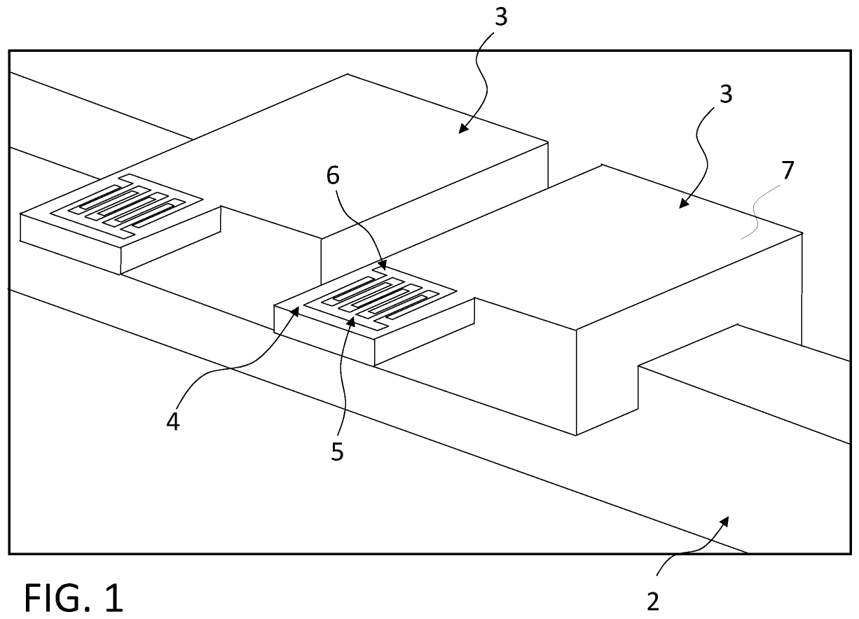

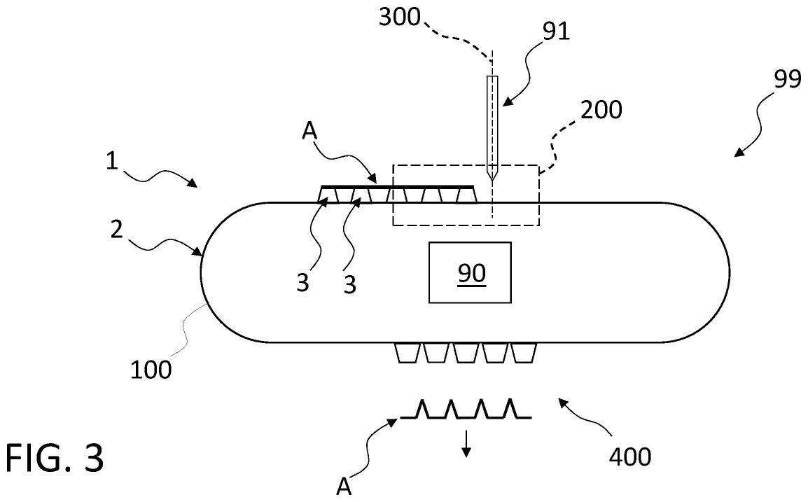

In FIG. 1, with the number 1, a linear transport system of articles A (exemplarily shown only in FIG. 3) is globally indicated.

Exemplarily, the transport system 1 comprises a linear fixed guide 2 and a set of support elements 3 slidingly engaging the fixed guide 2. The support elements can be of various numbers, depending on the process requirements. Exemplarily in FIG. 1 there are shown two support elements 3, while in FIG. 3, described more in detail below, there are shown five support elements 3.

Exemplarily each support element comprises a contact surface 4, and a first electrode 5 and a second electrode 6 in proximity of the contact surface 4. For instance, the electrodes can be made of one or more of the following materials: copper, aluminium, electrically conductive silicone rubber.

Exemplarily (FIG. 1), the contact surfaces 4 all have a planar shape and are coplanar to each other. The contact surfaces may have extension along curvilinear surfaces, or they may be planar but not coplanar to each other.

The support elements may be shaped for holding the article (or portion of article), for at least one portion of the treatment path, from below (i.e. the article on holding is in vertically superior position with respect to the contact surfaces 4, as exemplarily shown in FIG. 3 at the upper portion of the treatment path, as better described below) and/or from above (i.e. the article on holding is in vertically lower position in relation to the contact surfaces 4, as exemplarily shown in FIG. 3 at the lower portion of the treatment path), and/or from one or more sides (i.e. the contact surfaces are arranged vertically, as exemplarily shown in FIG. 3 at the curved connecting sections).

Exemplarily (FIG. 1), each first electrode 5 and second electrode 6 has main development substantially two-dimensional, parallel to the contact surface 4, and with comb shape with respective teeth mutually intermeshed.

Exemplarily each support element 3 comprises a main body 7, which in turn exemplarily comprises a carriage engaging the fixed guide 2 (only schematically shown, for example of known type).

Exemplarily each support element 3 comprises a support portion 8 comprising the contact surface 4. Exemplarily each support portion 8 is arranged cantilevered from the fixed guide 2.

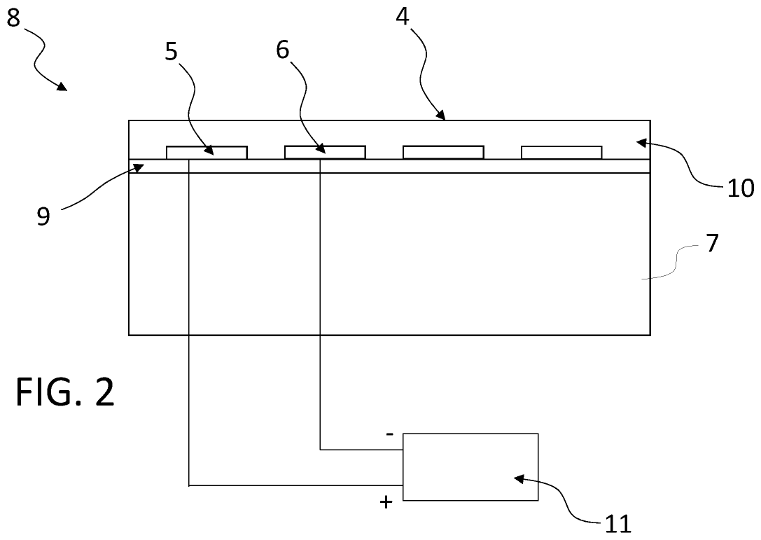

Exemplarily (FIG. 2), the support portion 8 has a layered structure comprising, proceeding towards the contact surface 4 (i.e. from the bottom to the top of FIG. 2):
a first dielectric substrate 9;
the first electrode 5 and the second electrode 6 arranged above the first dielectric substrate 9;
a second dielectric substrate 10 which incorporates the first electrode 5 and the second electrode 6. Exemplarily the second dielectric substrate 10 defines the contact surface 4.

The first and second dielectric substrates 9, 10 can be made of rigid, or flexible, or even extensible material.

Exemplarily, the first dielectric substrate 9 is made of Kapton™ and the second dielectric substrate 10 is made of silicone.

For instance, each support portion 8 can be made as described in the aforementioned article IEEE Robotics And Automation Letters, Vol. 5, No. 2, April 2020, pp. 2770-2776. Exemplarily the transport system 1 comprises an electric energy generator 11 (only schematically shown in FIG. 2) connected to the first electrode 5 and to the second electrode 6 of each support element 3. Exemplarily the electric energy generator 11 is capable of applying a voltage of approximately 7 kV to the ends of the electrodes, with a current flow (peak) which remains less than 50 μA.

The Applicant has noted that with the support elements according to the present invention, with suitably shaped and energised electrodes, it is possible to obtain retention forces of the portion of article against a contact surface 4 of an extension equal to about 10 cm², having intensities in the range of 50-60 N (for each support element). Such values revealed to be suitable for the handling of articles in high-capacity industrial processes. Exemplarily (not shown), the linear transport system 1 is structured for moving each support element 3 slidingly along the fixed guide 2 independently of the remaining support elements 3. For this purpose, each support element 3 exemplarily comprises a respective independent drive unit (not shown). Moreover, the linear transport system 1 comprises a subsystem of contactless communication (e.g. transmission and/or reception—not shown) of a signal (e.g. power signal and/or data signals) between the fixed guide 2 and each support element 3 (more preferably the respective drive unit and/or a respective processing unit incorporated on the support element—not shown) and/or vice versa. For instance, the signals may be mutually transmitted by inductive coupling between one or more stationary coils arranged on the fixed guide with one or more coils placed on each of the support elements.

For instance, the fixed guide, the one or more support elements slidingly engaging the guide, and the subsystem of communication, as such, may be of the type described in US2021/0046826 A1, to the extent compatible herewith.

With reference to FIG. 3, it shows a machine 99 comprising the linear transport system 1 above-described, and a control unit 90 connected to the linear transport system 1 (e.g. to the guide and to the support elements, for example by the aforementioned subsystem of communication) and for commanding each support element in movement along the fixed guide. Exemplarily the linear guide 2 defines a treatment path.

In FIG. 3, the fixed guide 2 is exemplarily illustrated in purely schematic way by a line representing its line of main development 100 (i.e. the line along which the major physical dimension of the guide develops). This line of main development 100, traversed in a predetermined direction of motion by the support elements 3 (clockwise in the figure), identifies the aforementioned treatment path. Exemplarily, the line of main development 100 has closed-loop development, so that the support elements 3 can continuously recirculate along the guide to transport several subsequent articles. For simplicity of depiction, the line of main development 100 is shown entirely lying on a vertical stock plane (in FIG. 3 coincident with the plane of the figure). Alternatively, not shown, the line of development may entirely lie on a horizontal plane.

In not shown embodiments, the line of main development 100 may have any development in the three-dimensional space. In such embodiments, the line of main development may entirely lie on a vertical lying surface. In other words, opposite portions of the fixed guide, which respectively represent a forward and a return stroke of the support elements, are, at each point of the guide, vertically superimposed on each other.

Exemplarily, each drive unit is structured to be operated (e.g. powered and/or controlled) by the subsystem of communication, exemplarily by the control unit 90.

Exemplarily, the machine 99 is a machine for folding sheet articles, i.e. a machine designed to make one or more folds on the article that is initially fed to the machine in sheet form (e.g. flat).

Exemplarily, machine 99 comprises a folding station 200 (dashed rectangle), which exemplarily comprises (at least) one folding plane 300 perpendicular to the treatment path.

Exemplarily, the machine 99 also comprises a loading station (not shown) upstream of the folding station and structured for loading the article (flat sheet) onto the plurality of support elements (e.g. on rest on the respective contact surfaces), and an unloading station 400, downstream of the folding station 200 and structured for unloading the processed article (i.e. the folded sheet) from the plurality of support elements 3. Exemplarily, the article at the unloading station 400 is inverted by 180° with respect to the folding station, and it is unloaded by falling, once the electric field of electro-adhesion which keeps it in retention on the contact surfaces 4 is annulled.

Exemplarily, the machine 99 comprises a folding element 91, alternately movable from a distal position distal from the fixed guide to a proximal position proximal to the fixed guide along a purely vertical trajectory and entirely lying on the folding plane 300.

In use, the transport system 1 allows to perform a method for the linear transport of articles.

Exemplarily, the method comprises reversibly generating an electric field (not shown, having for example field lines developing from one electrode to the other in proximity of the contact surface and at least partially outside it) between the first electrode 5 and the second electrode 6 of each support element 3 at the respective contact surface 4.

Exemplarily, the method comprises placing a portion of an article on the contact surface 4 of at least one of the support elements 3, with the portion subjected to the electric field for reversibly holding the portion of the article against the contact surface 4 by the electric field (according to the principle of electro-adhesion).

Exemplarily, the method comprises moving the support elements slidingly along the fixed guide for transporting the article.

With reference to FIG. 3, wherein the transport system 1 is incorporated into the machine 99, the method exemplarily comprises a treatment of the article, for instance the making on the article of a plurality of folds (exemplarily one fold for each pair of directly consecutive support elements 3). In such embodiment, the control unit 90 is exemplarily configured for commanding each pair of directly consecutive support elements for reciprocally approaching, along the treatment path, the support elements of each pair to make a respective fold.

Moreover, in such embodiment, the control unit 90 is further configured for:
i) arranging, from time to time, the two support elements 3 of each pair in proximity, and respectively upstream and downstream, of the folding plane 300 (fixed) along the treatment path;
ii) moving the folding element 91 from the distal position to the proximal position, for bringing into contact the folding element with the article (for facilitating the folding, for example by only transmitting a mechanical impulse to the article so that the fold develops in the desired direction);
iii) bringing the folding element back to the distal position.

In one embodiment, the method exemplarily comprises adjusting a surface extension of the electrical field on the contact surface 4 as a function of a shape and/or dimension of a contact surface of the portion of article (for example in case of differently shaped articles to be transported at different times). For this purpose, advantageously, the first electrode 5 is made from a plurality of first sub-electrodes (not shown), each first sub-electrode being exemplarily selectively activated (independently) with respect to the other first sub-electrodes. Exemplarily, the second electrode 6 is made of a plurality of second sub-electrodes (not shown), each second sub-electrode being exemplarily selectively activatable (independently) with respect to the other second sub-electrodes. The first sub-electrodes and the second sub-electrodes are therefore exemplarily selectively activatable to generate an electric field as a function of a shape and/or dimension of a contact surface of the portion of article A. In such embodiment, generating the electric field comprises selectively activating one or more of the first sub-electrodes and/or one or more of the second sub-electrodes depending on the shape and/or extension of the contact surface of the article portion.

In one embodiment (advantageously combinable with the embodiment just described), the method comprises exemplarily transporting with the same transport system, articles of different shapes and/or sizes. To this end, the method may exemplarily comprise:
removing the article from the contact surface of at least one of the support elements, for example by deactivating said electric field;
arranging a respective portion of a further article resting onto the contact surface of at least one of the (free) support elements, wherein the respective portion of the further article has a shape and/or surface dimension different from the respective shape and/or surface dimension of the portion of the article (previously arranged onto the contact surface);
moving the support elements slidingly along the fixed guide for transporting the further article.

In one embodiment, (combinable with the previous two, just described) the method can provide transferring an article from one linear transport system to another. To this end, the method may exemplarily comprise:
providing a further linear transport system (not shown) exemplarily having the same features of the linear transport system 1, including the presence of a further linear fixed guide (not shown);
deactivating the electric field for removing the article from the contact surface 4 of at least one of the support elements 3;
reversibly generating a further electric field between a further first electrode and a further second electrode of one or more further support elements at a further respective contact surface of the further linear transport system;
arranging a further portion of the article (e.g. at opposite side of the article with respect to the aforementioned portion of the article) on the further contact surface of one or more of the further support elements, with the further portion subjected to the further electric field for reversibly holding the further portion of the article on rest onto the further contact surface by the further electric field;
moving the one or more further support elements slidingly along the further fixed guide for further transporting the article.

1-15. (canceled)

16. A linear transport system for transporting articles, wherein the system comprises:
a linear fixed guide;
one or more support elements slidingly engaging the fixed guide, wherein each support element comprises a contact surface for receiving at least one portion of an article, and a first electrode and a second electrode in proximity of the contact surface; and
an electric energy generator connected to the first electrode and the second electrode of each support element for reversibly generating an electric field between each first electrode and second electrode at the contact surface for reversibly holding the portion of the article against the contact surface.

17. The system according to claim 16, wherein each first electrode and second electrode has main development substantially two-dimensional and parallel to the contact surface, wherein each first electrode and second electrode has a comb shape with respective teeth mutually intermeshed.

18. The system according to claim 16, wherein the electric energy generator applies an electric voltage greater than or equal to 1 k V and an electric current less than or equal to 10 microAmperes.

19. The system according to claim 16, wherein each support element comprises a main body and a sustaining portion, wherein the sustaining portion of each support element comprises the contact surface and has a layered structure, wherein the layered structure of each support element comprises, proceeding towards the contact surface:
a first dielectric substrate;
the first electrode and second electrode arranged above the first dielectric substrate; and
a second dielectric substrate arranged above the first electrode and second electrode, wherein the second dielectric substrate defines the contact surface.

20. The system according to claim 19, wherein the first dielectric substrate and the second dielectric substrate are made of one or more of the following materials: polypropylene, polyimide, elastomeric silicone, water-based polyurethane, cellulose acetate.

21. The system according to claim 16, wherein the linear transport system is structured for moving each support element slidingly along the fixed guide independently from the remaining support elements.

22. A machine comprising the linear transport system according to claim 16 and a control unit connected to the linear transport system for commanding the one or more support elements in movement along the linear guide defining a treatment path.

23. The machine according to claim 22, wherein the machine is a machine for folding sheet articles, wherein the control unit is further configured for commanding at least two support elements directly consecutive for reciprocally approaching, along the treatment path, the at least two support elements directly consecutive.

24. The machine according to claim 23, comprising one or more folding elements, wherein each folding element is alternatively movable from one or more distal positions distal from the fixed guide to a proximal position proximal to the fixed guide wherein the folding element lies onto a folding plane, wherein the control unit is configured for:
i) arranging the at least two support elements in proximity, and respectively upstream and downstream, of the folding plane along the treatment path;
ii) moving a respective folding element from one of the one or more distal positions to the proximal position for bringing into contact the respective folding element with an article; and
iii) bringing the respective folding element back to one of the one or more distal positions.

25. A method for the linear transport of articles, wherein the method comprises:
providing a linear transport system, wherein the linear transport system comprises a linear fixed guide and one or more support elements slidingly engaging the fixed guide, wherein each support element comprises a contact surface for receiving at least one portion of an article, and a first electrode and a second electrode in proximity of the contact surface;
reversibly generating an electric field between the first electrode and the second electrode of one or more of the one or more support elements at the respective contact surface;
arranging a portion of an article on the contact surface of at least one of the one or more support elements with the portion subjected to the electric field for reversibly holding the portion of the article against the contact surface by means of the electric field; and
moving the one or more support elements slidingly along the fixed guide for transporting the article.

26. The method according to claim 25, wherein generating the electric field comprises applying an electric voltage difference between the first electrode and the second electrode greater than or equal to 0.5 k V and less than or equal to 7.6 kV.

27. The method according to claim 25, further comprising making one or more folds on the article.

28. The method according to claim 25, comprising adjusting a surface extension of the electric field on the contact surface as a function of a shape of a contact surface of the portion of article, or an extension of a contact surface of the portion of article, or both.

29. The method according to claim 25, wherein the first electrode is formed by a plurality of first sub-electrodes and the second electrode is formed by a plurality of second sub-electrodes, and wherein generating the electric field comprises selectively activating one or more of the first sub-electrodes, or one or more of the second sub-electrodes, or both, as a function of a shape of a contact surface of the portion of article, or an extension of a contact surface of the portion of article, or both.

30. The method according to claim 25, further comprising:
removing the article from the contact surface;
arranging a respective portion of a further article resting onto the contact surface of at least one of the one or more support elements, wherein the respective portion of the further article has a shape, or surface dimension, or both, different from a respective shape, or surface dimension, or both, of the portion of the article; and
moving the one or more support elements slidingly along the fixed guide for transporting the further article.
